(19) United States
(12) Patent Application Publication
(10) Pub. No.: US 2026/0025497 A1
(43) Pub. Date: Jan. 22, 2026

(54) ASYMMETRIC IN-LOOP FILTERS AT VIRTUAL BOUNDARIES

(71) Applicant: Nokia Technologies Oy, Espoo (FI)

(72) Inventors: Limin WANG, San Diego, CA (US); Seungwook HONG, San Diego, CA (US); Krit PANUSOPONE, San Diego, CA (US)

(21) Appl. No.: 18/993,601

(22) PCT Filed: May 17, 2023
(86) PCT No.: PCT/EP2023/063275

§ 371 Date: Jan. 13, 2025

Related U.S. Application Data
(60) Provisional application No. 63/388,385, filed on Jul. 12, 2022.

(51) Int. Cl. H04N 19/117; H04N 19/167; H04N 19/182; H04N 19/82; H04N 19/86

(52) U.S. Cl. CPC H04N 19/117; H04N 19/167; H04N 19/182; H04N 19/82; H04N 19/86

(57) ABSTRACT

In accordance with example embodiments of the invention there is at least a method and an apparatus to perform: determining a virtual boundary that separates a picture, or a portion of the picture, into a first area and a second area; and determining to perform filtering of at least one pixel of the first area with coding information of the second area derived from the first area or with the coding information of the second area set to at least one value, when the coding information of the second area is to be used to perform the filtering of the at least one pixel of the first area, or determine to not perform the filtering of the at least one pixel of the first area, when the coding information of the second area is to be used to perform the filtering of the at least one pixel of the first area.

### TECHNICAL FIELD

The examples and non-limiting embodiments relate generally to multimedia transport and information encoding and decoding, more particularly, to asymmetric in-loop filters at virtual boundaries.

### BACKGROUND

It is known to perform data compression and decoding in a multimedia system.

### BRIEF DESCRIPTION OF THE DRAWINGS

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 shows schematically a block chart of an encoder used for data compression on a general level.

FIG. 5 illustrates that a refreshed are is not allowed to use coding information of a non-refreshed area.

FIG. 6 illustrates that a non-refreshed area is allowed to use coding information of a refreshed area.

FIG. 7 shows that deblocking may not be applied to pixels pᵢ, i=0,1,2, or still applied with pixels qᵢ, i=0,1,2, in the non-refreshed area padded.

FIG. 8 shows four edge classes.

FIG. 9 shows four edge categories.

FIG. 10A depicts that SAO edge offset may not be applied for pixel p₀, or still applied with pixel q₀ padded.

FIG. 10B depicts that SAO edge offset may not be applied for pixel q₀, or still applied with pixel p₀ padded.

FIG. 11 depicts that the offsets from BIF-luma, SAO and CCSAO are added to the deblocking output.

FIG. 12A depicts that BIF may not be applied for pixels p_{0,0}, or still applied with associated pixels, including q_{i,0}, i=0,1, padded.

FIG. 12B depicts that BIF may not be applied for pixels q_{0,0}, or still applied with associated pixels, including p_{i,0}, i=0,1, padded.

FIG. 13 depicts a decoding workflow of CCSAO.

FIG. 14 illustrates that for a collocated chroma sample, the collocated luma sample can be chosen from 9 candidate positions.

FIG. 15A shows that CCSAO may not be applied for pixel p₀, or still applied with pixel q₀ padded.

FIG. 15B shows that CCSAO may not be applied for pixel q₀, or still applied with pixel p₀ padded.

FIG. 16A shows that ALF may not be applied for pixels p_{0,0}, or still applied with the associated pixels, including q_{i,0}, i=0,1,2, padded.

FIG. 16B shows that ALF may not be applied for pixels q_{0,0}, or still applied with the associated pixels, including p_{i,0}, i=0,1,2, padded.

FIG. 17 is a basic illustration of CCALF in VVC.

FIG. 18 depicts a 25-tap filter for CCALF in ECM.

FIG. 19A shows that CCALF may not be applied for at least one of the collocated chroma pixels, or still applied with luma pixels q_{i,j}, i=0,1,2,3 and j=0,1, padded.

FIG. 19B shows that CCALF may not be applied for at least one of the collocated chroma pixels, or still applied with luma pixels p_{i,j}, i=0,1,2,3 and j=0,1, padded.

FIG. 20 is an example apparatus configured to implement asymmetric in-loop filters at virtual boundaries, based on the examples described herein.

FIG. 21 is an example method to implement asymmetric in-loop filters at virtual boundaries, based on the examples described herein.

### DETAILED DESCRIPTION OF EXAMPLE EMBODIMENTS

Described herein is a practical approach to implement asymmetric in-loop filters at virtual boundaries. The models described herein may be used to perform any task, such as data compression, data decompression, video compression, video decompression, image or video classification, object classification, object detection, object tracking, speech recognition, language translation, music transcription, etc.

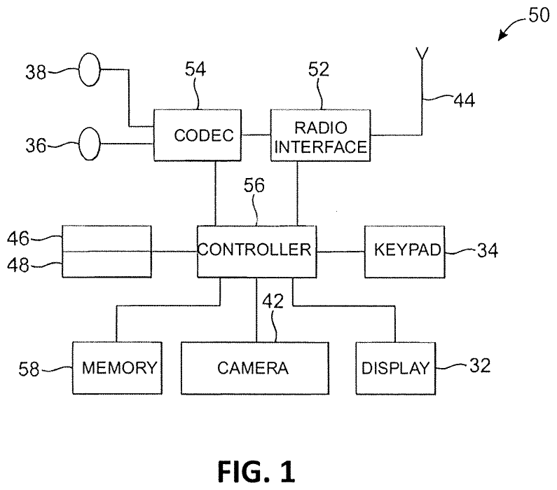

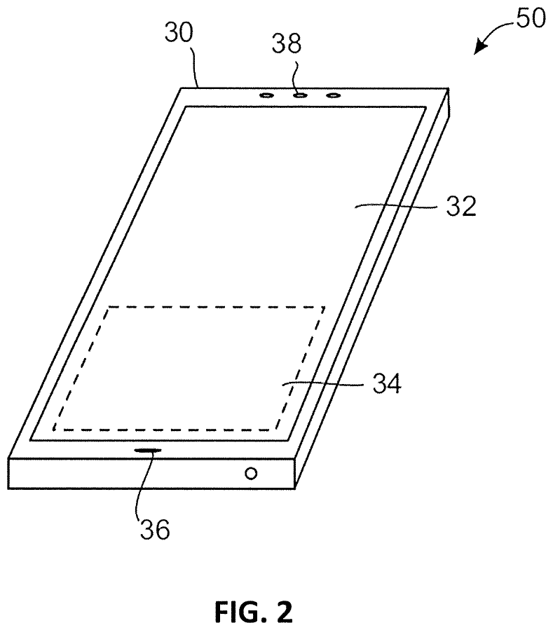

The following describes in detail a suitable apparatus and possible mechanisms to implement aspects of asymmetric in-loop filters at virtual boundaries. In this regard reference is first made to FIG. 1 and FIG. 2, where FIG. 1 shows an example block diagram of an apparatus 50. The apparatus may be an Internet of Things (IoT) apparatus configured to perform various functions, such as for example, gathering information by one or more sensors, receiving or transmitting information, analyzing information gathered or received by the apparatus, or the like. The apparatus may comprise a neural network weight update coding system, which may incorporate a codec. FIG. 2 shows a layout of an apparatus according to an example embodiment. The elements of FIG. 1 and FIG. 2 are explained next.

The electronic device 50 may for example be a mobile terminal or user equipment of a wireless communication system, a sensor device, a tag, or other lower power device. Alternatively, the electronic device may be a computer or part of a computer that is not mobile. However, it would be appreciated that embodiments of the examples described herein may be implemented within any electronic device or apparatus which may process data.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display an image or video. The apparatus 50 may further comprise a keypad 34 (or touch area 34). In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analog signal input. The apparatus 50 may further comprise an audio output device which in embodiments of the examples described herein may be any one of: an earpiece 38, speaker, or an analog audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera 42 capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the examples described herein may store both data in the form of image and audio data and/or may also store instructions for implementation on the controller 56. The controller 56 may further be connected to codec circuitry 54 suitable for carrying out coding/compression of neural network weight updates and/or decoding of audio and/or video data or assisting in coding and/or decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) such as a network node, and/or for receiving radio frequency signals from other apparatus(es).

The apparatus 50 may comprise a camera capable of recording or detecting individual frames which are then passed to the codec 54 or the controller for processing. The apparatus may receive the video image data or machine learning data for processing from another device prior to transmission and/or storage. The apparatus 50 may also receive either wirelessly or by a wired connection the image for coding/decoding. The structural elements of apparatus 50 described above represent examples of means for performing a corresponding function.

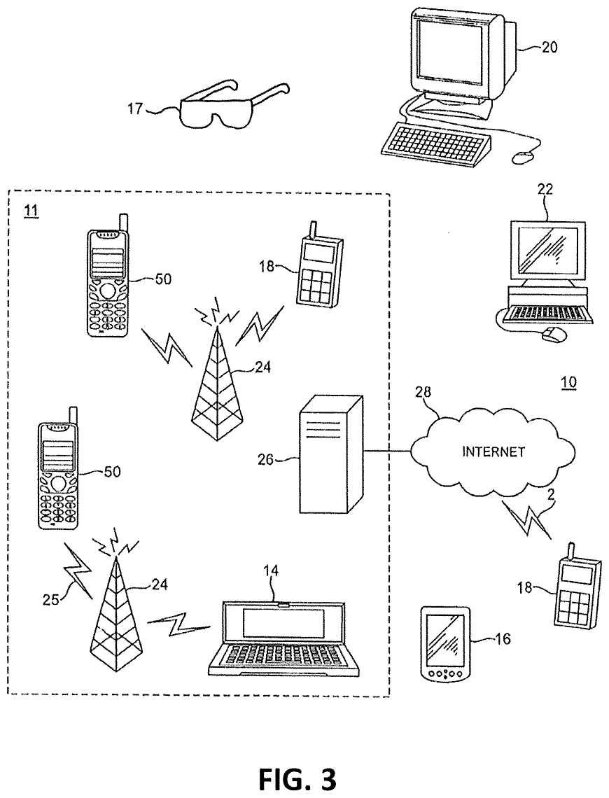

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA, LTE, 4G, 5G network etc.), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the internet 28, which is accessible to the various devices shown in FIG. 3 using communication link 2 (wired or wireless). Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport, or a head mounted display (HMD) 17.

The embodiments may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

One application where asymmetric in-loop filters at virtual boundaries and model level update skipping in compressed incremental learning is important, is the use case of neural network based codecs, such as neural network based video codecs. Video codecs may use one or more neural networks. In a first case, the video codec may be a conventional video codec such as the Versatile Video Codec (VVC/H.266) that has been modified to include one or more neural networks. Examples of these neural networks are:
1. a neural network filter to be used as one of the in-loop filters of VVC
2. a neural network filter to replace one or more of the in-loop filter(s) of VVC
3. a neural network filter to be used as a post-processing filter
4. a neural network to be used for performing intra-frame prediction
5. a neural network to be used for performing inter-frame prediction.

In a second case, which is usually referred to as an end-to-end learned video codec, the video codec may comprise a neural network that transforms the input data into a more compressible representation. The new representation may be quantized, lossless compressed, then lossless decompressed, dequantized, and then another neural network may transform its input into reconstructed or decoded data.

In both of the above two cases, there may be one or more neural networks at the decoder-side, and consider the example of one neural network filter. The encoder may finetune the neural network filter by using the ground-truth data which is available at encoder side (the uncompressed data). Finetuning may be performed in order to improve the neural network filter when applied to the current input data, such as to one or more video frames. Finetuning may comprise running one or more optimization iterations on some or all the learnable weights of the neural network filter. An optimization iteration may comprise computing gradients of a loss function with respect to some or all the learnable weights of the neural network filter, for example by using the backpropagation algorithm, and then updating the some or all learnable weights by using an optimizer, such as the stochastic gradient descent optimizer. The loss function may comprise one or more loss terms. One example loss term may be the mean squared error (MSE). Other distortion metrics may be used as the loss terms. The loss function may be computed by providing one or more data to the input of the neural network filter, obtaining one or more corresponding outputs from the neural network filter, and computing a loss term by using the one or more outputs from the neural network filter and one or more ground-truth data. The difference between the weights of the finetuned neural network and the weights of the neural network before finetuning is referred to as the weight-update. This weight-update needs to be encoded, provided to the decoder side together with the encoded video data, and used at the decoder side for updating the neural network filter. The updated neural network filter is then used as part of the video decoding process or as part of the video post-processing process. It is desirable to encode the weight-update such that it requires a small number of bits. Thus, the examples described herein consider also this use case of neural network based codecs as a potential application of the compression of weight-updates.

In further description of the neural network based codec use case, an MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Available media file format standards include ISO base media file format (ISO/IEC 14496-12, which may be abbreviated ISOBMFF) and file format for NAL unit structured video (ISO/IEC 14496-15), which derives from the ISOBMFF.

A video codec consists of an encoder that transforms the input video into a compressed representation suited for storage/transmission and a decoder that can decompress the compressed video representation back into a viewable form. A video encoder and/or a video decoder may also be separate from each other, i.e. need not form a codec. Typically the encoder discards some information in the original video sequence in order to represent the video in a more compact form (that is, at lower bitrate).

Typical hybrid video encoders, for example many encoder implementations of ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC; a.k.a. intra-block-copy prediction and current picture referencing), prediction is applied similarly to temporal prediction but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process as temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in the spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

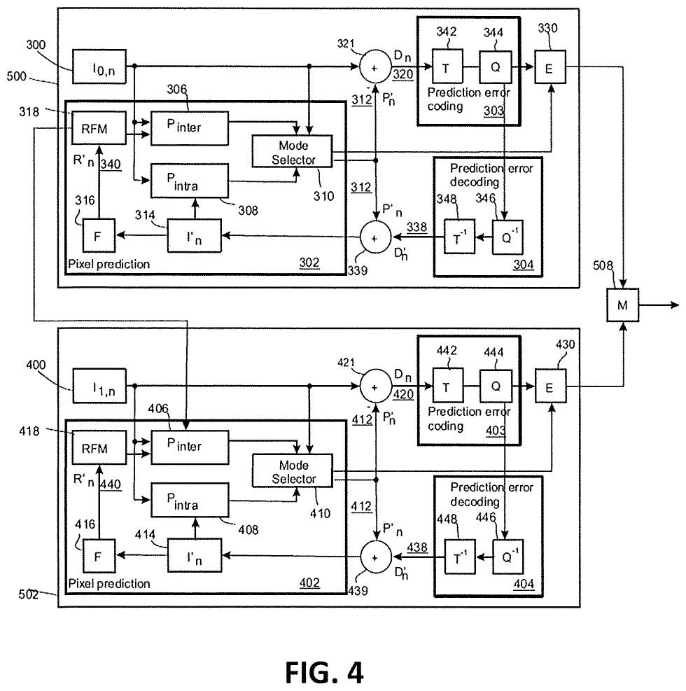

FIG. 4 shows a block diagram of a general structure of a video encoder. FIG. 4 presents an encoder for two layers, but it would be appreciated that presented encoder could be similarly extended to encode more than two layers. FIG. 4 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406 (Pᵢₙₜₑᵣ), an intra-predictor 308, 408 (Pᵢₙₜᵣₐ), a mode selector 310, 410, a filter 316, 416 (F), and a reference frame memory 318, 418 (RFM). The pixel predictor 302 of the first encoder section 500 receives 300 base layer images (I_{0,n}) of a video stream to be encoded at both the inter-predictor 306 (which determines the difference between the image and a motion compensated reference frame 318) and the intra-predictor 308 (which determines a prediction for an image block based only on the already processed parts of the current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 502 receives 400 enhancement layer images (I_{1,n}) of a video stream to be encoded at both the inter-predictor 406 (which determines the difference between the image and a motion compensated reference frame 418) and the intra-predictor 408 (which determines a prediction for an image block based only on the already processed parts of the current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 (Dₙ) which is input to the prediction error encoder 303, 403.

The pixel predictor 302, 402 further receives from a preliminary reconstructor 339, 439 the combination of the prediction representation of the image block 312, 412 (P′ₙ) and the output 338, 438 (D′ₙ) of the prediction error decoder 304, 404. The preliminary reconstructed image 314, 414 (I′ₙ) may be passed to the intra-predictor 308, 408 and to the filter 316, 416. The filter 316, 416 receiving the preliminary representation may filter the preliminary representation and output a final reconstructed image 340, 440 (R′ₙ) which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be the source for inter-layer sample prediction and/or inter-layer motion information prediction of the enhancement layer according to some embodiments, the reference frame memory 318 may also be connected to the inter-predictor 406 to be used as the reference image against which a future enhancement layer picture 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 500 may be provided to the second encoder section 502 subject to the base layer being selected and indicated to be the source for predicting the filtering parameters of the enhancement layer according to some embodiments.

The prediction error encoder 303, 403 comprises a transform unit 342, 442 (T) and a quantizer 344, 444 (Q). The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder 304, 404 may be considered to comprise a dequantizer 346, 446 (Q⁻¹), which dequantizes the quantized coefficient values, e.g. DCT coefficients, to reconstruct the transform signal and an inverse transformation unit 348, 448 (T⁻¹), which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 (E) receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508 (M).

The concept of virtual boundaries was introduced in VVC. A picture may be divided into different regions by virtual boundaries from a coding dependency perspective. For example, 360°: virtual boundaries are used to define the boundaries of different faces of a 360° picture in CMP format, and GDR (with reference to U.S. provisional application No. 63/296,590, “New Gradual Decoding Refresh for ECM”, filed by Applicant of this disclosure), where a virtual boundary separates the refreshed area and non-refreshed area of a GDR/recovering picture. In VVC, virtual boundaries are specified in a SPS and/or a picture header.

There are three in-loop filters in VVC. They are deblocking, SAO and ALF. ECM enhances the in-loop filters with new features, including Bilateral (JVET-F0034, JVET-V0094), BIF for chroma (JVET-X0067), CCSAO (JVET-V0153, JVET-Y0106), CCALF (JVET-X0045), and Alternative band classifier for ALF (JVET-X0070).

In-loop filtering of a current pixel often requires use of coding information of its neighbors. Hence, filtering on one side of a virtual boundary may involve use of coding information on other side of the virtual boundary.

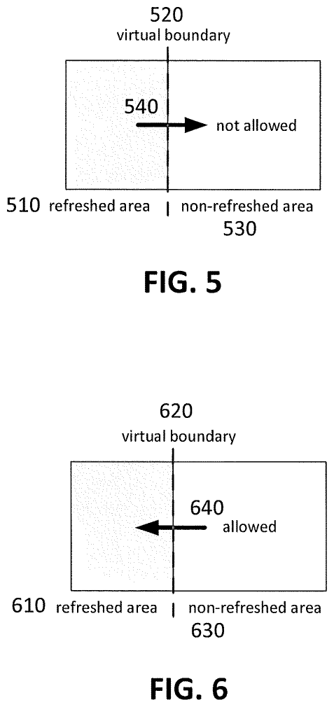

For some applications, it may not be allowed to have in-loop filtering cross a virtual boundary. For example, in GDR, a GDR/recovering picture may be divided into a refreshed area and a non-refreshed area by a virtual boundary. Referring to FIG. 5, to avoid leaks, the refreshed area 510 cannot use any information of non-refreshed area 530, because there is no guarantee that the non-refreshed area 530 is decoded correctly at the decoder. Incorrectly decoded coding information may contaminate the refreshed area 510, which may result in leaks or mismatch of the encoder and decoder at recovery point pictures and successive pictures. Hence, for a GDR/recovering picture, in-loop filtering cannot cross the virtual boundary 520 from refreshed area 510 to non-refreshed area 530, as indicated by the arrow 540.

On the other hand, sometimes it is perfectly fine to let in-loop filtering cross a virtual boundary. For example, as shown in FIG. 6, in the same example of GDR, the non-refreshed area 630 can use information of refreshed area 610. Hence, for a GDR/recovering picture, in-loop filtering can cross the virtual boundary 620 from non-refreshed area 630 to refreshed area 610, as indicated by the arrow 640.

In the current designs of VVC and ECM, in-loop filtering cannot cross virtual boundaries.

U.S. provisional application No. 63/362,243, “In-Loop Filtering at Virtual Boundaries”, filed by Applicant of this disclosure, proposed several possible options of in-loop filtering at virtual boundaries. Among them is asymmetric in-loop filtering at a virtual boundary. With this asymmetric option, in-loop filtering cannot cross a virtual boundary from one side of the virtual boundary to the other side of the virtual boundary, but can from the other side to the one side.

Specifically, in-loop filtering of one side of a virtual boundary cannot use information of the other side of the virtual boundary, but in-loop filtering of the other side of the virtual boundary can use information of the one side. If in-loop filtering for a pixel in the one side of the virtual boundary requires use of any information (e.g. pixels, coding mode, QP, etc.) of the other side, in-loop filtering is either not performed for the pixel or still performed for the pixel but with padding the information of the other side.

With asymmetric in-loop filtering at a virtual boundary, in-loop filtering of one side cannot use information of other side, but in-loop filtering of the other side is allowed to use information of the one side.

In-loop filtering of a pixel in the one side may not be performed normally if in-loop filtering of the pixel requires use of coding information of the other side.

In general, in-loop filtering of a pixel in the other side can be performed normally because in-loop filtering of the pixel is allowed to use the coding information of both the one side and the other side. But, the other side may choose not to use the coding information of the one side, in which case, in-loop filtering of a pixel in the other side may not be performed normally if in-loop filtering of the pixel requires use of coding information of the one side.

Since the coding information of the one side is available for the other side, an offset based upon in-loop filtering of the one side may be added to the output of in-loop filtering of the other side.

A virtual boundary is a line, that is used to separate a picture, or a portion of a picture, into two areas; a first area and a second area.

A virtual boundary can be vertical or horizontal. In VVC and ECM, virtual boundary syntax is included in the SPS and/or picture header. In one embodiment, such as with asymmetric operation at a virtual boundary, the first area is not allowed to use any information of the second area, but the second area can use the information of the first area.

In one embodiment, in a GDR/recovering picture, the first area is a clean (refreshed) area and the second area is a dirty (non-refreshed) area. The clean (refreshed) area cannot use any information of the dirty (non-refreshed) area, but the dirty (non-refreshed) area can use information of the clean (refreshed) area. In-loop filtering for a pixel may involve in use of coding information of its neighbors.

If in-loop filtering of a pixel in the first area requires use of coding information (e.g. pixels, coding mode, reference picture, MV, QP, etc.) of the second area, in-loop filtering of the pixel may not be performed normally. Actual in-loop filtering for the pixel may take one of two possible options, option 1 where in-loop filtering for the pixel in the first area is not performed, or option 2 where in-loop filtering for the pixel in the first area is still performed, but with the coding information of the second area derived from the first area, or set to pre-determined values, when needed.

One embodiment related to option 2 is that if in-loop filtering of a pixel in the first area requires use of pixels in the second area, the pixels in the second area are padded from the pixels in the first area.

Another embodiment related to option 2 is that if in-loop filtering of a pixel in the first area requires use of pixels in the second area, the pixels in the second area are replaced by the pixels extrapolated from the first area.

Let normal in-loop filtering of a pixel be ideal in-loop filtering of the pixel with using all the necessary information, and actual in-loop filtering of a pixel be practical in-loop filtering of the pixel with or without using all the necessary information.

Actual in-loop filtering of a pixel in either option 1 or 2 generates an output that may be different from the normal in-loop filtering of the pixel which can use the coding information of both the first area and the second area.

In-loop filtering for pixels in the second area can generally be performed normally because in-loop filtering for pixels in the second area is allowed to use the coding information of both the first area and the second area.

Let p_{i,j} be a pixel in the first area, and \hat{p}_{i,j} and \tilde{p}_{i,j} be the output of normal and actual in-loop filtering of p_{i,j}, respectively, and let q_{i,j} be a pixel in the second area, and \hat{q}_{i,j} and \tilde{q}_{i,j} be the output of normal and actual in-loop filtering of q_{i,j}, respectively.

At a virtual boundary, actual in-loop filtering of pixel p_{i,j} in the first area may not be equal to normal in-loop filtering of the pixel, that is, (\hat{p}_{i,j}≠\tilde{p}_{i,j}), if in-loop filtering of pixel p_{i,j} requires use of coding information of the second area.

On the other hand, at the virtual boundary, actual in-loop filtering of pixel q_{i,j} in the second area is generally equal to normal in-loop filtering of the pixel, that is (\hat{q}_{i,j}=\tilde{q}_{i,j}), because actual in-loop filtering of pixel q_{i,j} can use coding information of both the first and the second area.

To compensate the unbalanced in-loop filtering at virtual boundaries, the difference between normal and actual in-loop filtering of the first area may be compensated through in-loop filtering of the second area. Note that it is workable to offset the second area using the first area because the second area can use the coding information of the first area.

Specifically, if normal and actual in-loop filtering of pixel p_{i,j} in the first area is different, that is (\hat{p}_{i,j}≠\tilde{p}_{i,j}), the difference (\hat{p}_{i,j}−\tilde{p}_{i,j}) or its approximation may be used to offset the output of in-loop filtering of a corresponding pixel q_{m,n} in the second area. A possible example is as follows.

$${\hat{q}}_{m , n}^{′} = {\hat{q}}_{m , n} - {\sum }_{i , j} {w}_{i , j} ( {\hat{p}}_{i , j} - {\tilde{p}}_{i , j} )$$

where \hat{q}′_{m,n} is the final output of in-loop filtering of q_{m,n}, and w_{i,j} is the weight for the contribution of (\hat{p}_{i,j}−\tilde{p}_{i,j}) to q_{m,n}.

In one embodiment, the second area may choose not to use the coding information of the first area. In that case, if in-loop filtering of a pixel in the second area requires use of coding information of the first area, in-loop filtering of the pixel may not be performed normally. Similar to the first area, actual in-loop filtering for the pixel may take one of two possible options, option 1 where in-loop filtering for the pixel in the second area is not performed, or option 2 where in-loop filtering for the pixel in the second area is still performed, but with the coding information of the first area derived from the second area, or set to pre-determined values, when needed.

One embodiment related to the above option 2 is that if in-loop filtering of a pixel in the second area requires use of pixels in the first area, the pixels in the first area are padded from the pixels in the second area.

Another embodiment related to the above option 2 is that if in-loop filtering of a pixel in the second area requires use of pixels in the first area, the pixels in the first area are replaced by the pixels extrapolated from the second area.

The difference between target and actual in-loop filtering of pixel p_{i,j} in the first area may be used to offset the output of in-loop filtering of a corresponding pixel q_{m,n} in the second area. A possible example is as follows.

$${\tilde{q}}_{m , n}^{′} = {\tilde{q}}_{m , n} - {\sum }_{i , j} {w}_{i , j} ( {\overline{p}}_{i , j} - {\tilde{p}}_{i , j} )$$

where \tilde{q}′_{m,n} is the final output of in-loop filtering of q_{m,n}, \tilde{q}_{m,n} is the output of in-loop filtering of q_{m,n}, \tilde{p}_{i,j} is the output of target in-loop filtering of p_{i,j}, and w_{i,j} is the weight for the contribution of (\tilde{p}_{i,j}−\tilde{p}_{i,j}) to q_{m,n}.

In one embodiment, if the first area and the second area choose the same option for in-loop filtering of pixels around virtual boundaries, that is either not perform in-loop filtering or perform it with padding, in-loop filtering of the first area and the second area may be deemed as balanced. Compensation may not be needed on either side of a virtual boundary.

One embodiment is related to a deblocking filter in VVC and ECM. Deblocking filtering is applied to a (horizontal or vertical) block boundary, involving pixels on both sides of the block boundary.

Assume a virtual boundary separates a picture or a portion of a picture into a first area and a second area, and the first area is not allowed to use coding information in the second area, but the second area can use coding information in the first area.

If the block boundary is aligned with the virtual boundary, deblocking filtering for pixels in the first area up to n (e.g. 1 for chroma weak filter, 2 for luma weak filter, 3 for luma and chroma strong filters, 3, 5, 7 for luma bilinear (long) filters in the current design of VVC and ECM) pixel positions away from the virtual boundary requires use of coding information (e.g. pixels, coding mode, QP, etc.) in the second area.

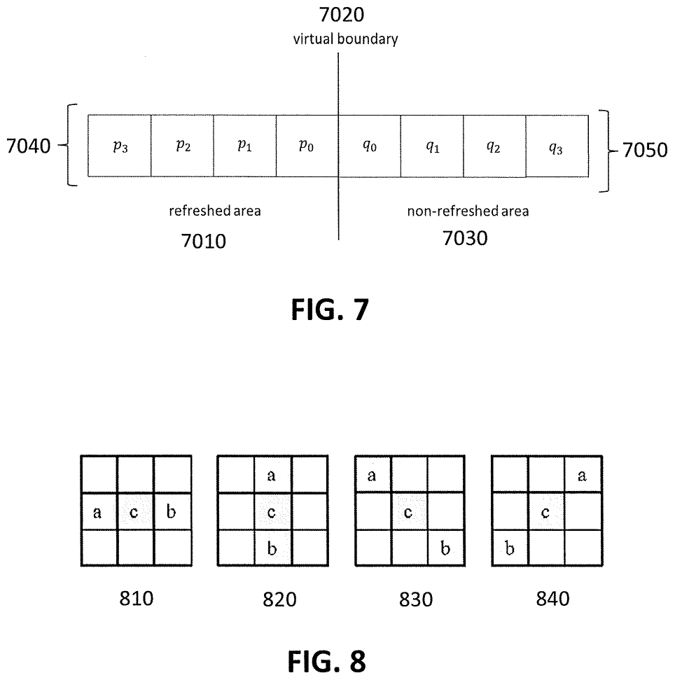

Since the first area is not allowed to use coding information in the second area, deblocking filtering is disabled for those pixels in the first area up to n pixel positions away from the virtual boundary. FIG. 7 shows an example where the refreshed area (the first area) 7010 of a GDR/recovering picture is not allowed to use coding information of non-refreshed area (the second area) 7030. Deblocking (e.g. strong filter) 7040 is disabled for pixels, pᵢ, i=0,1,2, in the refreshed area 7010 next to the virtual boundary 7020.

Alternatively, deblocking filtering 7040 is still applied to those pixels in the first area up to n pixel positions away from the virtual boundary 7020, but with the coding information in the second area derived from the first area or set to pre-determined values, when needed. For example, in FIG. 7, deblocking (e.g. strong filter) is still applied to pixels (generally 7040), pᵢ, i=0,1,2, in the refreshed area 7010 next to the virtual boundary 7020, but with the associated pixels 7050, including qᵢ, i=0,1,2, in the non-refreshed area 7030 derived from the refreshed area 7010. For example, qᵢ, i=0,1,2, may be set to be equal to p₀, or the mean or the median of pᵢ, i=0,1,2.

Deblocking for pixels on the second area can be performed normally with being allowed to use the coding information of both the first area 7010 and the second area 7030.

If actual deblocking filtering of a pixel pᵢ in the first area 7010 is different from the normal deblocking filtering, the difference can be offset from a corresponding pixel qᵢ as

$${\hat{q}}_{i}^{′} = {\hat{q}}_{i} - {\sum }_{j} {w}_{i , j} ( {\hat{p}}_{j} - {\tilde{p}}_{j} )$$

where \hat{q}′ᵢ is the final output of deblocking filtering of qᵢ, \hat{q}ᵢ is the output of deblocking filtering of qᵢ, \hat{p}ᵢ is the output of normal deblocking filtering of pᵢ with using all the necessary information including information of the first area 7010 and/or the second area 7030, \tilde{p}ᵢ is the output of actual deblocking filtering of pᵢ, w_{i,j} is the weight for the contribution of (\hat{p}ⱼ−\tilde{p}ⱼ) to qᵢ, and i and j are pixel indices indicating the positions away from the virtual boundary (e.g. i=0 indicting the position just next to the virtual boundary).

One possible embodiment can be as follows,

$${\hat{q}}_{i}^{′} = {\hat{q}}_{i} - {\sum }_{j = 0}^{s p - 1} \frac{1}{{2}^{i + j}} ( {\hat{p}}_{j} - {\tilde{p}}_{j} ) \qquad for i = 0 , … , sq - 1$$

where sp and sq are filter lengths for pixels pᵢ in the first area and pixels qᵢ in the second area, respectively.

A simple embodiment can even be as follows,

$${\hat{q}}_{i}^{′} = {\hat{q}}_{i} - \frac{1}{{2}^{i}} ( {\hat{p}}_{i} - {\tilde{p}}_{i} ) .$$

The corresponding pixels pᵢ and qᵢ are the mirrored pixels in the first area 7010 and the second area 7030 before deblocking with respect to the block boundary or the virtual boundary 7020, as shown in FIG. 7.

If the second area 7030 chooses not to use coding information of the first area 7010, deblocking filtering is not applied to pixels in the second area 7030 up to n (e.g. 1 for chroma weak filter, 2 for luma weak filter, 3 for luma and chroma strong filters, 3, 5, 7 for luma bilinear (long) filters in the current design of VVC and ECM) pixel positions away from the virtual boundary. FIG. 7 may show an example where the non-refreshed area (the second area) 7030 of a GDR/recovering picture chooses not to use coding information of refreshed area (the first area) 7010. Deblocking (e.g. a strong filter) is disabled for pixels, qᵢ, i=0,1,2, in the non-refreshed area 7030 next to the virtual boundary 7020.

Alternatively, deblocking filtering is still applied to those pixels 7050 in the second area 7030 up to n pixel positions away from the virtual boundary 7020, but with the coding information in the first area 7010 derived from the second area 7030 or set to pre-determined values. For example, in FIG. 7, deblocking (e.g. a strong filter) may still be applied to pixels (generally 7050), qᵢ, i=0,1,2, in the non-refreshed area 7030 next to the virtual boundary 7020, but with the associated pixels 7040, including pᵢ, i=0,1,2, in the refreshed area 7010 derived from the non-refreshed area 7030. For example, pᵢ, i=0,1,2, may be set to be equal to q₀, or a mean or median of qᵢ, i=0,1,2.

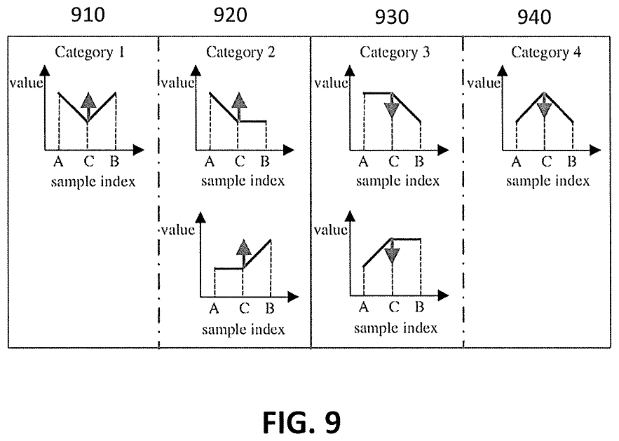

One embodiment is related to an SAO edge offset filter. In VVC, SAO has two parts. They are band offset and edge offset. Each CTU can choose to use either band offset or edge offset. The choice of band offset or edge offset per CTU is signaled. For a CTU, if edge offset is used, a set of parameters (edge class, as shown in FIG. 8, and offsets for four edge categories, as shown in FIG. 9), is signaled.

Referring to FIG. 8, illustrated is an example of four edge classes. In example 810, pixels a and b are horizontally adjacent to pixel c. In example 820, pixels a and b are vertically adjacent to pixel c. In example 830, pixels a and b are adjacent to pixel c along a slope from the upper left to the lower right. In example 840, pixels a and b are adjacent to pixel c along a slope from the lower left to the upper right.

Referring to FIG. 9, illustrated is an example of four edge categories. In category 1, 910, the value of pixel c is lower than the values of pixels a and b. In category 2, 920, the value of pixels c and b may be similar, while the value of pixel a may be higher than that of pixels c and b. Alternatively, the values of pixels a and c may be similar, while the value of pixel b may be higher than that of pixels a and c. In category 3, 930, the value of pixels a and c may be similar, while the value of pixel b may be lower than that of pixels a and c. Alternatively, the values of pixels c and b may be similar, while the value of pixel a may be lower than that of pixels c and b. In category 4, 940, the value of pixel c may be higher than that of pixels a and b.

As seen from FIG. 8 and FIG. 9, categorizing the edge of a pixel involves use of the neighboring pixels.

Assume a virtual boundary separates a picture or a portion of a picture into a first area and a second area, and the first area is not allowed to use coding information in the second area, but the second area can use coding information in the first area.

SAO edge offset for pixels in the first area just next to the virtual boundary may require use of coding information (e.g. pixels) in the second area, as shown in FIG. 8.

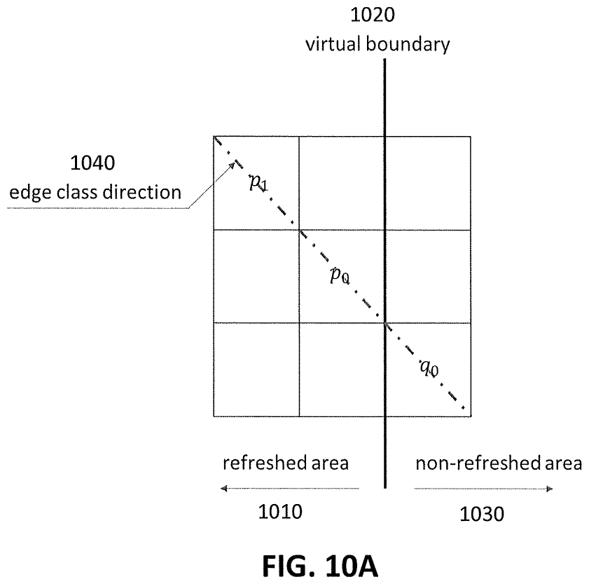

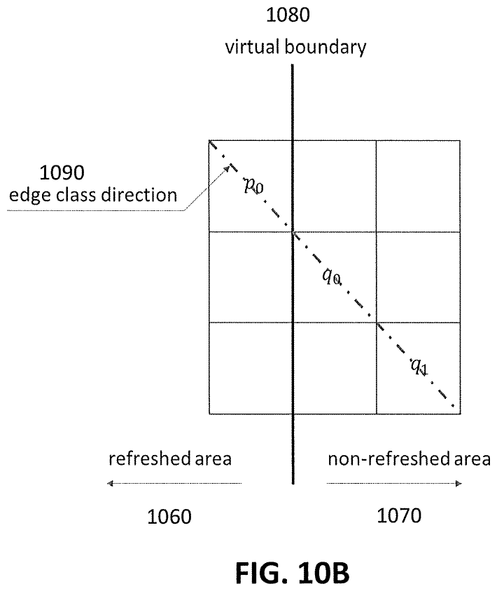

Since the first area is not allowed to use coding information of the second area, SAO edge offset is not applied to those pixels in the first area just next to the virtual boundary. FIG. 10A shows an example where the refreshed area (the first area) 1010 of a GDR/recovering picture is not allowed to use coding information of non-refreshed area (the second area) 1030. SAO edge offset with diagonal class direction 1040 is disabled for pixel p₀ in the refreshed area 1010, which is just next to the virtual boundary 1020.

Alternatively, SAO edge offset (e.g. 1040) is still applied to the pixels in the first area 1010 just next to the virtual boundary 1020, but with the coding information (e.g. pixels) in the second area 1030 derived from the first area 1010 or set to pre-determined values, when needed. For example, in FIG. 10A, SAO edge offset is still applied to pixel p₀ in the refreshed area 1010 just next to the virtual boundary 1020, but with the associated pixel, q₀, on the non-refreshed area 1030 padded from the refreshed area 1010 (or set to a pre-determined value, e.g. 2^{BD-1}, where BD is bit depth).

SAO edge offset for pixels in the second area 1030 next to the virtual boundary 1020 can be performed normally with being allowed to use the coding information of both the first area 1010 and the second area 1030.

If actual SAO edge offset filtering of pixel p₀ in the first area 1010 is different from the normal SAO edge offset filtering, the difference can be offset from a corresponding pixel q₀ as

$${\hat{q}}_{0}^{′} = \hat{{q}_{0}} - ( {\hat{p}}_{0} - {\tilde{p}}_{0} )$$

where \hat{q}′₀ is the final output of SAO edge offset filtering of q₀, \hat{q}₀ is the output of SAO edge offset filtering of q₀, \hat{p}₀ is the output of normal SAO edge offset filtering of p₀ with using all the necessary information including information of the first area 1010 and/or the second area 1030, and \tilde{p}₀ is the output of actual SAO edge offset filtering of p₀.

The corresponding pixels p₀ and q₀ are the mirror pixels with respect to the joint point of the virtual boundary and SAO edge offset class direction line along the selected SAO edge class direction line 1040, as shown in FIG. 10A.

If the second area chooses not to use coding information of the first area, SAO edge offset is not applied to pixels in the second area next to the virtual boundary. FIG. 10B shows an example where the non-refreshed area (the second area) 1070 of a GDR/recovering picture chooses not to use coding information of refreshed area (the first area) 1060. SAO edge offset is not applied to pixel, q₀, in the non-refreshed area 1070 next to the virtual boundary 1080.

Alternatively, SAO edge offset is still applied to those pixels in the second area 1070 next to the virtual boundary 1080, but with the coding information in the first area 1060 derived from the second area 1070 or set to pre-determined values, when needed. For example, in FIG. 10B, SAO edge offset is still applied to pixel, q₀, in the non-refreshed area 1070 next to the virtual boundary 1080, but with the associated pixel, p₀, in the refreshed area 1060 padded from the non-refreshed area 1070. Shown in FIG. 10B is edge class direction line 1090.

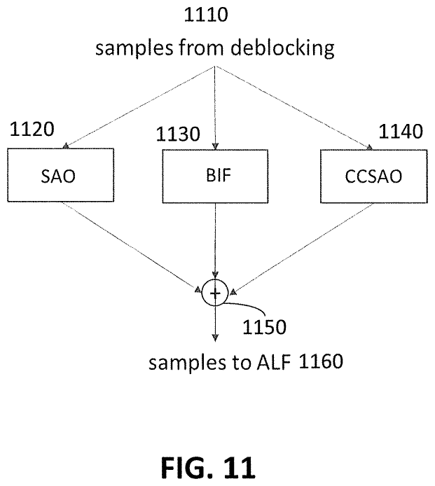

One embodiment is related to a bilateral filter (BIF) for luma and chroma. ECM enhances in-loop filters of VVC by adding new filter features. Among them is a bilateral filter. As shown in FIG. 11, BIF 1130 is performed in parallel with the SAO 1120 and CCSAO process 1140. BIF (1130), SAO (1120) and CCSAO (1140) use the same samples produced by the deblocking filter (1110) as input and generate three offsets per sample in parallel. Then these three offsets are added (with operation 1150) to the input sample to obtain a sum, which is then clipped to form the final output sample value (1160), before proceeding to ALF. The BIF-chroma provides an on/off control mechanism on the CTU level and slice level.

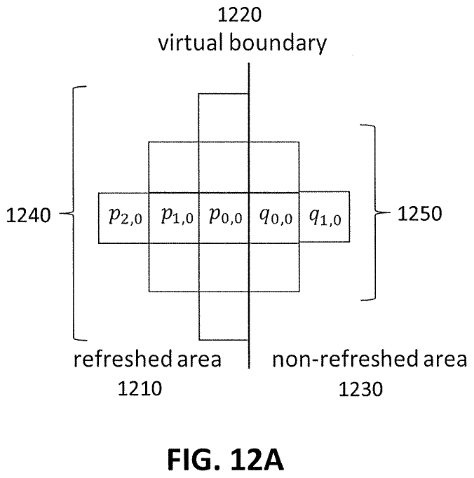

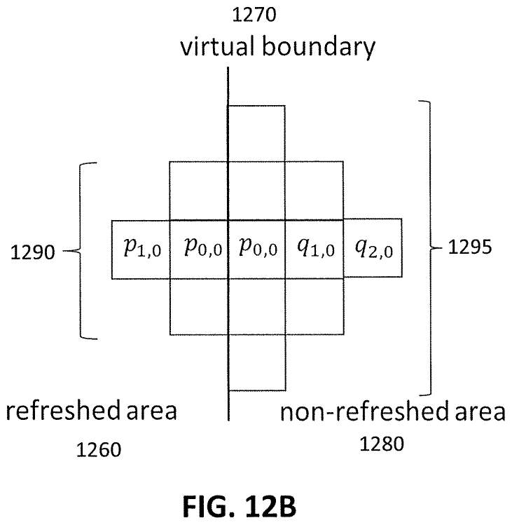

The bilateral filter is of a 5×5 diamond shape for both luma and chroma, as shown in FIG. 12A, where the bilateral filter is applied on a pixel next to a virtual boundary.

Assume a virtual boundary separates a picture or a portion of a picture into a first area and a second area, and the first area is not allowed to use coding information in the second area, but the second area can use coding information in the first area.

BIF filtering for pixels in the first area up to n (e.g. 2 in the current design of BIF) pixel positions away from the virtual boundary requires use of coding information (e.g. pixels) in the second area.

Since the first area is not allowed to use coding information of the second area, BIF filtering may be disabled for those pixels in the first area up to n (e.g. 2 in the current design of BIF) pixel positions away from the virtual boundary. FIG. 12A shows an example where the refreshed area (the first area) 1210 of a GDR/recovering picture is not allowed to use coding information of non-refreshed area (the second area) 1230. BIF filtering is not performed for pixel p_{0,0} in the refreshed area 1210 next to the virtual boundary 1220.

Alternatively, BIF filtering is still performed for those pixels 1240 in the first area up to n (e.g. 2 in the current design of BIF) pixel positions away from the virtual boundary, but with the coding information on the second area derived from the first area or set to pre-determined values, when needed. For example, in FIG. 12A, BIF filtering is still applied to pixel p_{0,0} in the refreshed area 1210 next to the virtual boundary 1220, but with the associated pixels, including q_{i,0}, i=0,1, in the non-refreshed area 1230 padded from the refreshed area (or set to a pre-determined value, e.g. 2^{BD-1}, where BD is bit depth).

BIF filtering for pixels 1250 on the second area 1230 can be performed normally with being allowed to use the coding information of both the first area 1210 and the second area 1230.

If actual BIF filtering of a pixel p_{i,j} in the first area 1210 is different from the normal deblocking filtering, the difference can be offset from a corresponding pixel q_{m,n} as

$${\hat{q}}_{m , n}^{′} = {\hat{q}}_{m , n} - {\sum }_{i , j} {w}_{i , j} ( {\hat{p}}_{i , j} - {\tilde{p}}_{i , j} )$$

where \hat{q}′_{m,n} is the final output of BIF filtering of q_{m,n}, \hat{q}_{m,n} is the output of BIF filtering of q_{m,n}, \hat{p}_{i,j} is the output of normal BIF filtering of p_{i,j} with using all the necessary information including information of the first area 1210 and/or the second area 1230, and \tilde{p}_{i,j} is the output of actual BIF filtering of p_{i,j}.

The corresponding pixels p_{i,j} and q_{i,j} are the mirrored pixels in the first area 1210 and the second area 1230 before BIF with respect to the virtual boundary 1220, as shown in FIG. 12A.

If the second area chooses not to use coding information of the first area, BIF filtering is not applied to pixels in the second area up to n (e.g. 2 in the current design of BIF) pixel positions away from the virtual boundary. FIB. 12B shows an example where the non-refreshed area (the second area 1280) of a GDR/recovering picture chooses not to use coding information of refreshed area (the first area) 1260. BIF is disabled for pixel, q_{0,0}, in the non-refreshed area 1280 next to the virtual boundary 1270.

Alternatively, BIF filtering is still applied to those pixels 1295 in the second area 1280 up to n pixel positions away from the virtual boundary 1270, but with the coding information in the first area 1260 derived from the second area 1280 or set to pre-determined values, when needed. For example, in FIG. 12B, BIF is still applied to pixels (generally 1295), including q_{0,0}, in the non-refreshed area 1280 next to the virtual boundary 1270, but with the associated pixels (generally 1290), including p_{i,0}, i=0,1, in the refreshed area 1260 padded from the non-refreshed area 1280.

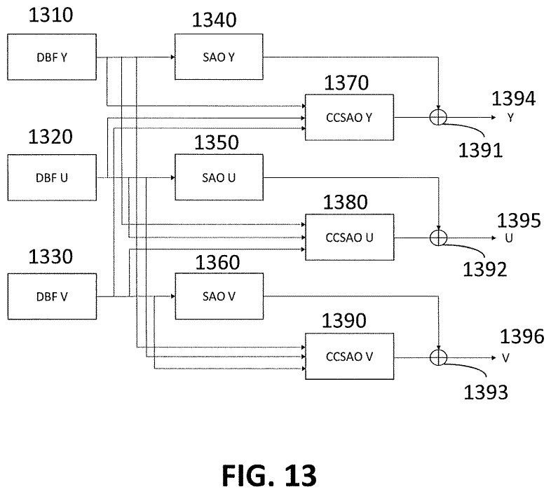

One embodiment is related to a CCSAO filter. Cross-component sample adaptive offset (CCSAO) is used to refine reconstructed samples. Similarly to SAO, the CCSAO classifies the reconstructed samples into different categories, derives one offset for each category and adds the offset to the reconstructed samples in that category. However, as shown in FIG. 13, different from SAO (1340, 1350, 1360) which uses one single luma/chroma component (one of 1310, 1320, 1330) of the current sample as input, the CCSAO (1370, 1380, 1390) utilizes all three components (1310, 1320, 1330) to classify the current sample into different categories. To facilitate the parallel processing, the output samples from the de-blocking filter are used as the input of the CCSAO.

Output of CCSAO Y 1370 is combined (e.g. added or subtracted) with output of SAO Y 1340 using operation 1391 to generate Y 1394. Output of CCSAO U 1380 is combined (e.g. added or subtracted) with output of SAO U 1350 using operation 1392 to generate U 1395. Output of CCSAO V 1390 is combined (e.g. added or subtracted) with output of SAO V 1350 using operation 1393 to generate V 1396.

In CCSAO, either a band offset (BO) classifier or an edge offset (EO) classifier is used to enhance the quality of the reconstructed samples. CCSAO may be applied to both luma and chroma components.

In CCSAO BO, for a given luma/chroma sample, three candidate samples are selected to classify the given sample into different categories, namely one collocated Y sample, one collocated U sample, and one collocated V sample. The sample values of these three selected samples are then classified into three different bands and a joint index represents the category of the given sample. One offset is signaled and added to the reconstructed samples that fall into that category.

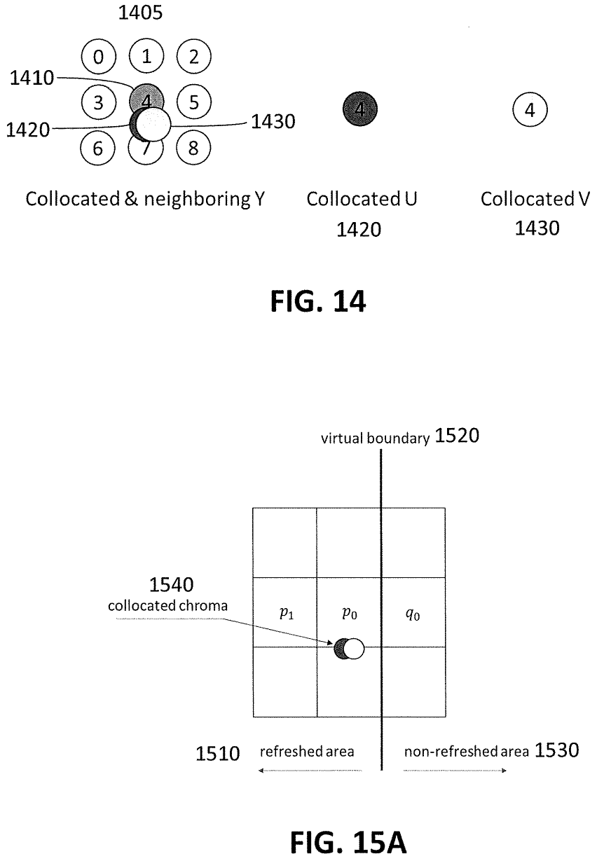

As depicted in FIG. 14, the collocated luma sample 1410 can be chosen from 9 candidate positions (1405), while the collocated chroma sample positions (1420, 1430) are fixed.

Assume a virtual boundary separates a picture or a portion of a picture into a first area and a second area, and the first area is not allowed to use coding information in the second area, but the second area can use coding information in the first area.

CCSAO for pixels in the first area just next to the virtual boundary may require use of coding information (e.g. pixels) in the second area.

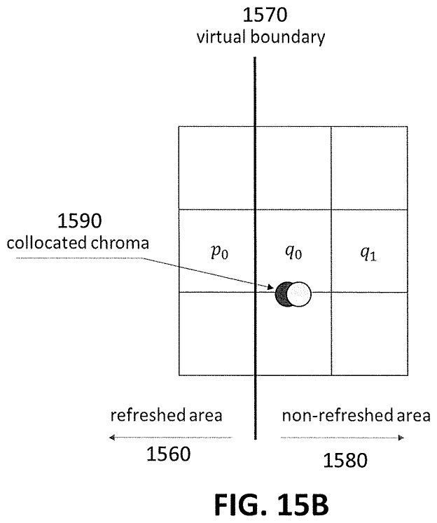

Since the first area is not allowed to use coding information of the second area, CCSAO is not applied to those pixels in the first area just next to the virtual boundary. FIG. 15A shows an example where the refreshed area (the first area) 1510 of a GDR/recovering picture is not allowed to use coding information of non-refreshed area (the second area) 1530. CCSAO is skipped for pixel p₀ in the refreshed area 1510 just next to the virtual boundary 1520. Shown in FIG. 15A is collocated chroma 1540.

Alternatively, CCSAO is still applied to those pixels in the first area just next to the virtual boundary, but with the coding information in the second area derived from the first area or set to pre-determined values, when needed. For example, in FIG. 15A, CCSAO is still applied to pixel p₀ in the refreshed area 1510 next to the virtual boundary 1520, but with the associated pixel, q₀, in the non-refreshed area 1530 padded from the refreshed area 1510 (or set to a pre-determined value, e.g. 2^{BD-1}, where BD is bit depth).

CCSAO for pixels on the second area 1530 can be performed normally with being allowed to use the coding information of the first area 1510.

If actual CCSAO filtering of pixel p₀ in the first area 1510 is different from the normal SAO edge offset filtering, the difference can be offset from a corresponding pixel q₀ as

$${\hat{q}}_{0}^{′} = \hat{{q}_{0}} - ( {\hat{p}}_{0} - {\tilde{p}}_{0} )$$

where \hat{q}′₀ is the final output of CCSAO BO filtering of q₀, \hat{q}₀ is the output of CCSAO BO filtering of q₀, \hat{p}₀ is the output of normal CCSAO BO filtering of p₀ with using all the necessary information including information of the first area 1510 and/or the second area 1530, and \tilde{p}₀ is the output of actual CCSAO BO filtering of p₀.

The corresponding pixels p₀ and q₀ are the mirror pixels in the first area 1510 and the second area 1530 before CCSAO BO with respect to the virtual boundary, as shown in FIG. 15A.

If the second area chooses not to use coding information of the first area, CCSAO BO is not applied to pixels in the second area next to the virtual boundary. FIG. 15B shows an example where the non-refreshed area (the second area) 1580 of a GDR/recovering picture chooses not to use coding information of refreshed area (the first area) 1560. CCSAO BO is not applied to pixel, q₀, in the non-refreshed area 1580 next to the virtual boundary 1570.

Alternatively, CCSAO BO is still applied to those pixels in the second area 1580 next to the virtual boundary, but with the coding information in the first area 1560 derived from the second area 1580 or set to pre-determined values, when needed. For example, in FIG. 15B, CCSAO BO is still applied to pixel, q₀, in the non-refreshed area 1580 next to the virtual boundary 1570, but with the associated pixels, p₀, in the refreshed area 1560 padded from the non-refreshed area 1580. FIG. 15B shows collocated chroma 1590.

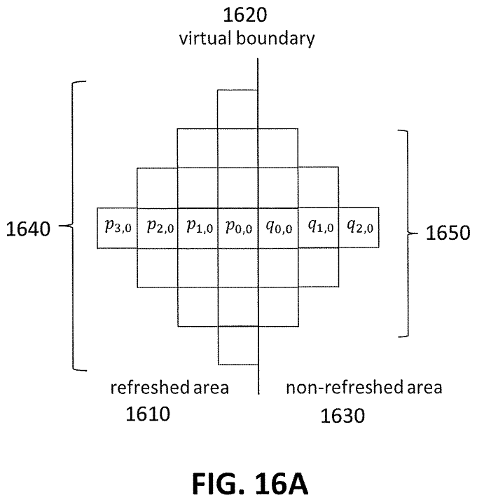

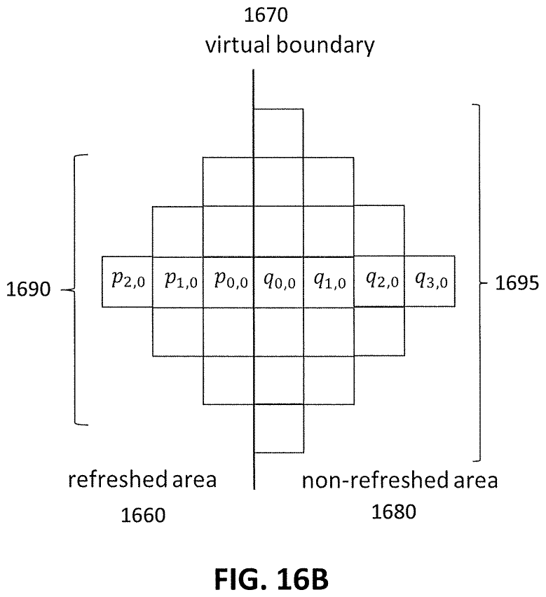

One embodiment is related to ALF filter. In VVC, ALF filter is of a diamond shape of size 7×7 for luma and 5×5 for chroma. ECM extends ALF sizes to 9×9, 7×7 and 5×5 for luma and chroma. FIG. 16A shows an example of an ALF filter of 9×9 diamond shape on a pixel next to a virtual boundary 1620. In addition, ECM adds an alternative band classifier for classification in ALF (ABC-ALF), which is a 13×13 diamond shape filter for classifying each 2×2 luma block for ALF.

Assume a virtual boundary separates a picture or a portion of a picture into a first area and a second area, and the first area is not allowed to use coding information in the second area, but the second area can use coding information in the first area.

ALF filtering for pixels in the first area up to n (e.g., 3 for luma and 2 for chroma ALF in the current design of VVC, 2, 3, 4 for luma and chroma ALF and 6 for ABC-ALF in the current design of ECM) pixel positions away from the virtual boundary requires use of coding information (e.g. pixels) in the second area.

Since the first area is not allowed to use the coding information of the second area, ALF filtering may be disabled for those pixels in the first area up to n positions away from the virtual boundary. FIG. 16A shows an example where the refreshed area (the first area) 1610 of a GDR/recovering picture is not allowed to use coding information of non-refreshed area (the second area) 1630. ALF is not performed for pixel p_{0,0} in the refreshed area 1610, which is just next to the virtual boundary 1620.

Alternatively, ALF is still applied to pixels (1640) in the first area 1610 up to n positions away from the virtual boundary 1620, but with the coding information on the second area 1630 derived from the first area 1610 or set to pre-determined values, when needed. For example, in FIG. 16A, ALF is still performed for pixel p_{0,0} in the refreshed area 1610 next to the virtual boundary 1620, but with the associated pixels 1650, including q_{i,0}, i=0,1,2, in the non-refreshed area 1630 padded from the refreshed area 1610 (or set to a pre-determined value, e.g. 2^{BD-1}, where BD is bit depth).

ALF filtering for pixels on the second area can be performed normally with being allowed to use the coding information of both the first area and the second area.

If actual ALF filtering of a pixel p_{i,j} in the first area 1610 is different from the normal deblocking filtering, the difference can be offset from a corresponding pixel q_{m,n} as

$${\hat{q}}_{m , n}^{′} = {\hat{q}}_{m , n} - {\sum }_{i , j} {w}_{i , j} ( {\hat{p}}_{i , j} - {\tilde{p}}_{i , j} )$$

where \hat{q}′_{m,n} is the final output of ALF filtering of q_{m,n}, \hat{q}_{m,n} is the output of ALF filtering of q_{m,n}, \hat{p}_{i,j} is the output of normal ALF filtering of p_{i,j} with using all the necessary information including information of the first area 1610 and/or the second area 1630, and \tilde{p}_{i,j} is the output of actual ALF filtering of p_{i,j}.

The corresponding pixels p_{i,j} and q_{i,j} are the mirrored pixels in the first area 1610 and the second area 1630 before ALF with respect to the virtual boundary 1620, as shown in FIG. 16A.

If the second area chooses not to use coding information of the first area, ALF is not applied to pixels in the second area up to n (e.g. 3 for luma and 2 for chroma ALF in the current design of VVC, 2, 3, 4 for luma and chroma ALF and 6 for ABC-ALF in the current design of ECM) pixel positions away from the virtual boundary. FIG. 16B shows an example where the non-refreshed area (the second area) 1680 of a GDR/recovering picture chooses not to use coding information of refreshed area (the first area) 1660. ALF is not applied to pixel, q_{0,0}, in the non-refreshed area 1680 next to the virtual boundary 1670.

Alternatively, ALF is still applied to those pixels 1695 in the second area 1680 next to the virtual boundary 1670, but with the coding information in the first area 1660 derived from the second area 1680 or set to pre-determined values, when needed. For example, in FIG. 16B, ALF is still applied to pixel, q_{0,0}, in the non-refreshed area 1680 next to the virtual boundary 1670, but with the associated pixels 1690, including p_{i,0}, i=0,1,2, in the refreshed area 1660 padded from the non-refreshed area 1680.

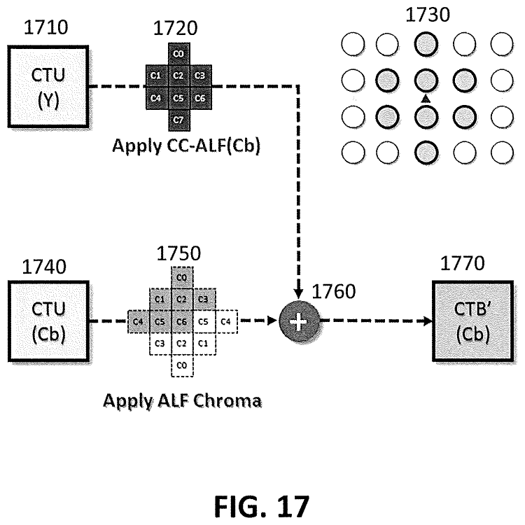

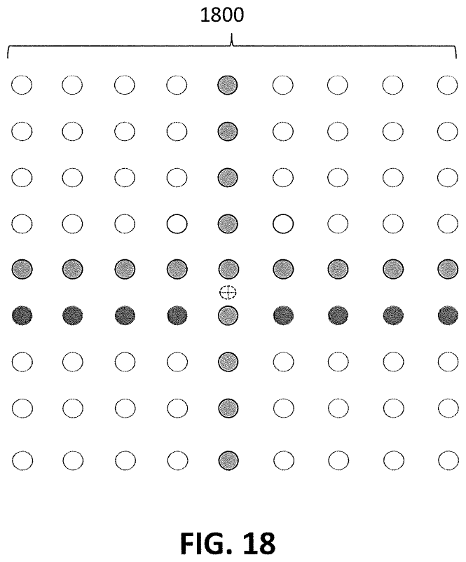

One embodiment is related to a CCALF filter. As shown in FIG. 17, the CCALF process 1720 uses a linear filter to filter luma sample values and generate a residual correction (1770) for the chroma samples. Initially, a 8-tap filer was designed for the CCALF process in VVC. Lately, a 25-tap large filter is used in the CCALF process in ECM (1800), which is illustrated in FIG. 18. For a given slice, the encoder can collect the statistics of the slice, analyze them and can signal up to 16 filters through an APS.

Referring to FIG. 17, illustrated is a basic example of CCALF. At CTU(Y) 1710, CCALF(Cb) may be applied 1720 to a collection of pixels, as illustrated at 1730. This may be considered linear filtering of luma sample values. At CTU(Cb) 1740, ALF chroma may be applied 1750 to a portion of the pixels. This may be considered filtering of chroma samples. The output of 1720 and 1750 may be added 1760 (or alternatively combined in some other way e.g. subtraction with operation 1760), and output as CTB′(Cb) 1770.

Assume a virtual boundary separates a picture or a portion of a picture into a first area and a second area, and the first area is not allowed to use coding information in the second area, but the second area can use coding information in the first area.

CCALF filtering for pixels in the first area up to n (e.g. 1 for VVC or 4 for ECM) pixel positions away from the virtual boundary requires use of coding information (e.g. pixels) in the second area.

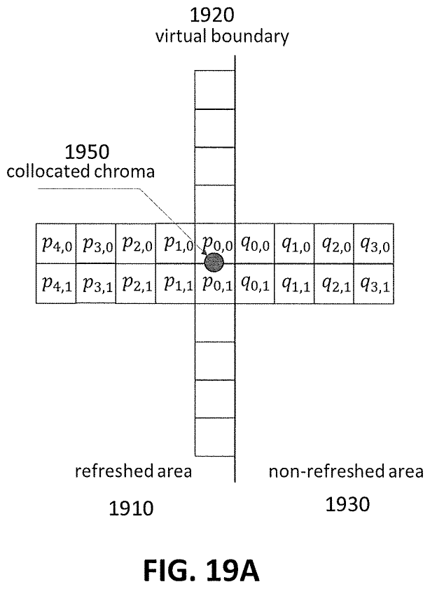

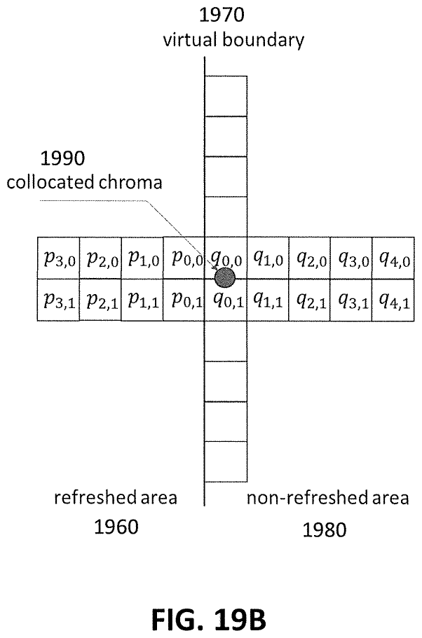

Since the first area is not allowed to use the coding information of the second area, CCALF filtering may be disabled for those pixels in the first area up to n pixel positions away from the virtual boundary. FIG. 19A shows an example where the refreshed area 1910 (the first area) of a GDR/recovering picture is not allowed to use coding information of non-refreshed area 1930 (the second area). CCALF is skipped for chroma pixel 1950 in the refreshed area 1910 just next to the virtual boundary 1920.

Alternatively, CCALF is still applied for those pixels in the first area up to n pixel positions away from the virtual boundary, but with the coding information in the second area derived from the first area or set to pre-determined values, when needed. For example, in FIG. 19A, CCALF is still applied to chroma pixel 1950 in the refreshed area 1910 next to the virtual boundary 1920, but with the associated luma pixels, including q_{i,j}, i=0,1,2,3, and j=0,1, on the non-refreshed area 1930 padded from the refreshed area 1910 (or set to a pre-determined value, e.g. 2^{BD-1}, where BD is bit depth).

CCALF for pixels on the second area can be performed normally with being allowed to use the information of the first area.

If actual CCALF filtering of a pixel p_{i,j} in the first area 1910 is different from the normal deblocking filtering, the difference can be offset from a corresponding pixel q_{i,j} as

$${\hat{q}}_{m , n}^{′} = {\hat{q}}_{m , n} - {\sum }_{i , j} {w}_{i , j} ( {\hat{p}}_{i , j} - {\tilde{p}}_{i , j} )$$

where \hat{q}′_{m,n} is the final output of CCALF filtering of q_{m,n}, \hat{q}_{m,n} is the output of CCALF filtering of q_{m,n}, \hat{p}_{i,j} is the output of normal CCALF filtering of p_{i,j} with using all the necessary information including information of the first area and/or the second area, and \tilde{p}_{i,j} is the output of actual CCALF filtering of p_{i,j}.

The corresponding pixels p_{i,j} and q_{i,j} are the mirrored pixels in the first area 1910 and the second area 1930 before CCALF with respect to the virtual boundary 1920, as shown in FIG. 19A.

If the second area chooses not to use coding information of the first area, CCALF is not applied to pixels in the second area up to n (e.g. 1 for VVC or 4 for ECM) pixel positions away from the virtual boundary. FIG. 19B shows an example where the non-refreshed area (the second area) 1980 of a GDR/recovering picture chooses not to use coding information of refreshed area (the first area) 1960. CCALF is skipped for the collocated chroma pixel 1990 in the non-refreshed area 1980 next to the virtual boundary 1970.

Alternatively, CCALF is still applied to those pixels in the second area 1980 next to the virtual boundary 1970, but with the coding information in the first area 1960 derived from the second area 1980 or set to pre-determined values, when needed. For example, in FIG. 19B, CCALF is still applied to the collocated chroma pixel 1990 in the non-refreshed area 1980 next to the virtual boundary 1970, but with the associated luma pixels, including p_{i,j}, i=0,1,2,3, and j=0,1, in the refreshed area 1960 padded from the non-refreshed area 1980.

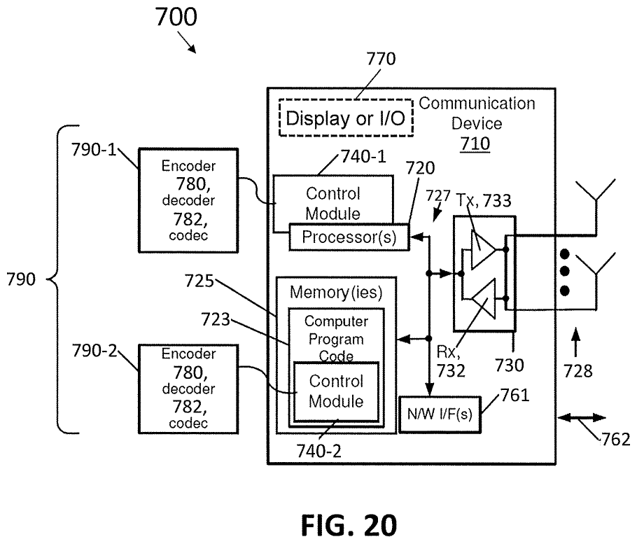

FIG. 20 is a block diagram 700 of an apparatus 710 suitable for implementing the example embodiments. One non-limiting example of the apparatus 710 is a wireless, typically mobile device that can access a wireless network. The apparatus 710 includes one or more processors 720, one or more memories 725, one or more transceivers 730, and one or more network (N/W) interfaces (I/F(s)) 761, interconnected through one or more buses 727. Each of the one or more transceivers 730 includes a receiver, Rx, 732 and a transmitter, Tx, 733. The one or more buses 727 may be address, data, or control buses, and may include any interconnection mechanism, such as a series of lines on a motherboard or integrated circuit, fiber optics or other optical communication equipment, and the like.

The apparatus 710 may communicate via wired, wireless, or both interfaces. For wireless communication, the one or more transceivers 730 are connected to one or more antennas 728. The one or more memories 725 include computer program code 723. The N/W I/F(s) 761 communicate via one or more wired links 762.

The apparatus 710 includes a control module 740, comprising one of or both parts 740-1 and/or 740-2, which include reference 790 that includes encoder 780, or decoder 782, or a codec of both 780/782, and which may be implemented in a number of ways. For ease of reference, reference 790 is referred to herein as a codec. The control module 740 may be implemented in hardware as control module 740-1, such as being implemented as part of the one or more processors 720. The control module 740-1 may be implemented also as an integrated circuit or through other hardware such as a programmable gate array. In another example, the control module 740 may be implemented as control module 740-2, which is implemented as computer program code 723 and is executed by the one or more processors 720. For instance, the one or more memories 725 and the computer program code 723 may be configured to, with the one or more processors 720, cause the user equipment 710 to perform one or more of the operations as described herein. The codec 790 may be similarly implemented as codec 790-1 as part of control module 740-1, or as codec 790-2 as part of control module 740-2, or both.

The computer readable memories 725 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 725 may be means for performing storage functions. The computer readable one or more memories 725 may be non-transitory, transitory, volatile (e.g. random access memory (RAM)) or non-volatile (e.g. read-only memory (ROM)). The computer readable one or more memories 725 may comprise a database for storing data.

The processors 720 may be of any type suitable to the local technical environment, and may include one or more of general-purpose computers, special purpose computers, microprocessors, digital signal processors (DSPs) and processors based on a multi-core processor architecture, as non-limiting examples. The processors 720 may be means for performing functions, such as controlling the apparatus 710, and other functions as described herein.

In general, the various embodiments of the apparatus 710 can include, but are not limited to, cellular telephones (such as smart phones, mobile phones, cellular phones, voice over Internet Protocol (IP) (VOIP) phones, and/or wireless local loop phones), tablets, portable computers, room audio equipment, immersive audio equipment, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptops, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain context), a consumer electronics device, a device operating on commercial and/or industrial wireless networks, and the like. That is, the apparatus 710 could be any device that may be capable of wireless or wired communication.

Thus, the apparatus 710 comprises a processor 720, at least one memory 725 including computer program code 723, wherein the at least one memory 725 and the computer program code 723 are configured to, with the at least one processor 720, cause the apparatus 710 to implement asymmetric in-loop filters 790 at virtual boundaries, based on the examples described herein. The apparatus 710 optionally includes a display or I/O 770 that may be used to display content during ML/task/machine/NN processing or rendering. Display or I/O 770 may be configured to receive input from a user, such as with a keypad, touchscreen, touch area, microphone, biometric recognition, one or more sensors, etc. Apparatus 710 may comprise standard well-known components such as an amplifier, filter, frequency-converter, and (de) modulator.

Computer program code 723 may comprise object oriented software, and may implement the filtering described throughout this disclosure. The apparatus 710 need not comprise each of the features mentioned, or may comprise other features as well. The apparatus 710 may be an embodiment of apparatuses shown in FIG. 1, FIG. 2, FIG. 3, or FIG. 4, including any combination of those.

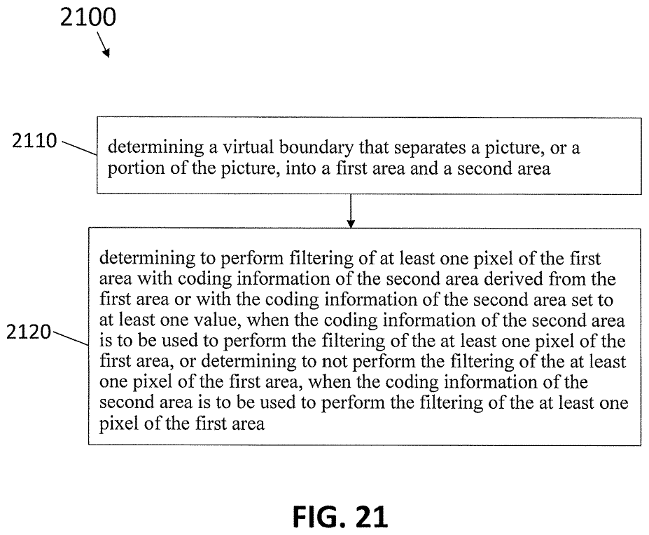

FIG. 21 is an example method 2100 to implement asymmetric in-loop filters at virtual boundaries, based on the examples described herein. At 2110, the method includes determining a virtual boundary that separates a picture, or a portion of the picture, into a first area and a second area. At 2120, the method includes determining to perform filtering of at least one pixel of the first area with coding information of the second area derived from the first area or with the coding information of the second area set to at least one value, when the coding information of the second area is to be used to perform the filtering of the at least one pixel of the first area, or determining to not perform the filtering of the at least one pixel of the first area, when the coding information of the second area is to be used to perform the filtering of the at least one pixel of the first area. Method 2100 may be performed by an encoder, decoder, or codec, or any of the apparatuses shown in FIG. 1, FIG. 2, FIG. 3, FIG. 4, or FIG. 20.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

The following examples (1-32) are described and provided herein.

Example 1. An apparatus includes at least one processor; and at least one memory including computer program code; wherein the at least one memory and the computer program code are configured to, with the at least one processor, cause the apparatus at least to: determine a virtual boundary that separates a picture, or a portion of the picture, into a first area and a second area; and determine to perform filtering of at least one pixel of the first area with coding information of the second area derived from the first area or with the coding information of the second area set to at least one value, when the coding information of the second area is to be used to perform the filtering of the at least one pixel of the first area, or determine to not perform the filtering of the at least one pixel of the first area, when the coding information of the second area is to be used to perform the filtering of the at least one pixel of the first area.

Example 2. The apparatus of example 1, wherein the filtering of the at least one pixel of the first area includes in-loop filtering.

Example 3. The apparatus of any of examples 1 to 2, wherein the first area includes a refreshed area, and the second area includes a non-refreshed area.

Example 4. The apparatus of any of examples 1 to 3, wherein the picture comprises a gradual decoding refresh picture or a recovering picture.

Example 5. The apparatus of any of examples 1 to 4, wherein the at least one memory and the computer program code are configured to, with the at least one processor, cause the apparatus at least to: pad pixels in the second area from pixels in the first area, in response to the pixels in the second area being used to perform the filtering of the at least one pixel of the first area.

Example 6. The apparatus of any of examples 1 to 5, wherein the at least one memory and the computer program code are configured to, with the at least one processor, cause the apparatus at least to: replace pixels in the second area with pixels extrapolated from the first area, in response to pixels in the second area being used to perform the filtering of the at least one pixel in the first area.

Example 7. The apparatus of any of examples 1 to 6, wherein the at least one memory and the computer program code are configured to, with the at least one processor, cause the apparatus at least to: determine a first output of the filtering of the at least one pixel of the first area, when coding information of the first area and the coding information of the second area are available for the filtering of the at least one pixel of the first area; and determine a second output of the filtering of the at least one pixel of the first area, when the coding information of the second area is not available for the filtering of the at least one pixel of the first area.

Example 8. The apparatus of example 7, wherein the at least one memory and the computer program code are configured to, with the at least one processor, cause the apparatus at least to: determine a difference between the first output and the second output; and determine an output of filtering at least one pixel of the second area, using at least partially the difference or an approximation of the difference.

Example 9. The apparatus of example 8, wherein the coding information of the second area includes the output of the filtering of the at least one pixel of the second area.

Example 10. The apparatus of any of examples 8 to 9, wherein a position of the at least one pixel of the second area corresponds to a position of the at least one pixel of the first area.

Example 11. The apparatus of any of examples 7 to 10, wherein the at least one memory and the computer program code are configured to, with the at least one processor, cause the apparatus at least to: determine a difference between the first output and the second output; determine an initial output of filtering at least one pixel of the second area; and determine a final output of the filtering of the at least one pixel of the second area, with subtracting at least partially the difference from the initial output; wherein the coding information of the second area includes the final output of the filtering of the at least one pixel of the second area.

Example 12. The apparatus of example 11, wherein the at least one memory and the computer program code are configured to, with the at least one processor, cause the apparatus at least to: determine the final output of the filtering of the at least one pixel of the second area, with subtracting at least partially a weighted contribution of the difference from the initial output.

Example 13. The apparatus of example 12, wherein the weighted contribution includes 1/2ⁱ, where i corresponds to an index of a position of the at least one pixel of the first area or the at least one pixel of the second area.

Example 14. The apparatus of any of examples 1 to 13, wherein the at least one memory and the computer program code are configured to, with the at least one processor, cause the apparatus at least to: determine a target output of a target filtering of the at least one pixel of the first area; determine an actual output of the filtering of the at least one pixel of the first area, when coding information of the first area or the coding information of the second area is not available to perform the filtering of the at least one pixel of the first area; determine a difference between the target output and the actual output; determine an initial output of filtering at least one pixel of the second area; and determine a final output of the filtering of the at least one pixel of the second area, using the initial output offset at least partially with the difference; wherein the coding information of the second area includes the final output of the filtering of the at least one pixel of the second area.

Example 15. The apparatus of any of examples 1 to 14, wherein the at least one memory and the computer program code are configured to, with the at least one processor, cause the apparatus at least to: determine whether to perform the filtering of the at least one pixel of the first area without using the coding information of the second area, and determine whether to perform filtering of the at least one pixel of the second area without using coding information of the first area, in response to determination of common option related to the filtering of the at least one pixel of the first area and the filtering of the at least one pixel of the second area.

Example 16. The apparatus of example 15, wherein the common option includes determining not to perform filtering of the at least one pixel of the first area, and determining not to perform filtering of the at least one pixel of the second area.

Example 17. The apparatus of any of examples 15 to 16, wherein the common option includes determining to perform filtering of the at least one pixel of the first area with padding the coding information of the second area, and determining to perform filtering of the at least one pixel of the second area with padding coding information of the first area.

Example 18. The apparatus of any of examples 1 to 17, wherein the at least one memory and the computer program code are configured to, with the at least one processor, cause the apparatus at least to: perform filtering of at least one pixel of the second area using coding information of the first area and the coding information of the second area.

Example 19. The apparatus of any of examples 1 to 18, wherein the filtering of the at least one pixel of the first area includes at least one of: deblocking filtering; sample adaptive offset edge offset filtering; bilatering filtering for luma; bilateral filtering for chroma; cross-component sample adaptive offset filtering; adaptive loop filtering; or cross-component adaptive loop filtering.

Example 20. The apparatus of any of examples 1 to 19, wherein the at least one memory and the computer program code are configured to, with the at least one processor, cause the apparatus at least to: disable the filtering of the at least one pixel of the first area up to a number of pixel positions from the virtual boundary.

Example 21. The apparatus of any of examples 1 to 20, wherein the at least one memory and the computer program code are configured to, with the at least one processor, cause the apparatus at least to: perform the filtering of the at least one pixel of the first area up to a number of pixel positions form the virtual boundary.

Example 22. The apparatus of any of examples 1 to 21, wherein the at least one memory and the computer program code are configured to, with the at least one processor, cause the apparatus at least to perform at least one of: set pixel values of the second area to be equal to a pixel value of the first area next to the virtual boundary; set pixel values of the second area to be equal to a mean of pixel values of the first area; or set pixel values of the second area to be equal to a median of pixel values of the first area; wherein the coding information of the second area includes the set pixel values of the second area.

Example 23. The apparatus of any of examples 1 to 22, wherein the at least one memory and the computer program code are configured to, with the at least one processor, cause the apparatus at least to: determine to perform filtering of at least one pixel of the second area with coding information of the first area derived from the second area or with the coding information of the first area set to at least one value, when the coding information of the first area is to be used to perform the filtering of the at least one pixel of the second area, or determine to not perform the filtering of the at least one pixel of the second area, when the coding information of the first area is to be used to perform the filtering of the at least one pixel of the second area.

Example 24. The apparatus of example 23, wherein the at least one memory and the computer program code are configured to, with the at least one processor, cause the apparatus at least to: disable filtering of at least one pixel of the second area up to a number of pixel positions from the virtual boundary.

Example 25. The apparatus of any of examples 23 to 24, wherein the at least one memory and the computer program code are configured to, with the at least one processor, cause the apparatus at least to: perform the filtering of the at least one pixel of the second area up to a number of pixel positions form the virtual boundary.

Example 26. The apparatus of any of examples 23 to 25, wherein the at least one memory and the computer program code are configured to, with the at least one processor, cause the apparatus at least to perform at least one of: set pixel values of the first area to be equal to a pixel value of the second area next to the virtual boundary; set pixel values of the first area to be equal to a mean of pixel values of the second area; or set pixel values of the first area to be equal to a median of pixel values of the second area; wherein the coding information of the first area includes the set pixel values of the first area.

Example 27. The apparatus of any of examples 23 to 26, wherein the filtering of the at least one pixel of the second area includes at least one of: in-loop filtering; deblocking filtering; sample adaptive offset edge offset filtering; bilatering filtering for luma; bilateral filtering for chroma; cross-component sample adaptive offset filtering; adaptive loop filtering; or cross-component adaptive loop filtering.

Example 28. The apparatus of any of examples 1 to 27, wherein the at least one memory and the computer program code are configured to, with the at least one processor, cause the apparatus at least to: determine the at least one value with a bit depth BD.

Example 29. The apparatus of example 28, wherein the at least one memory and the computer program code are configured to, with the at least one processor, cause the apparatus at least to: determine the at least one value as 2^{BD-1}.

Example 30. A method includes determining a virtual boundary that separates a picture, or a portion of the picture, into a first area and a second area; and determining to perform filtering of at least one pixel of the first area with coding information of the second area derived from the first area or with the coding information of the second area set to at least one value, when the coding information of the second area is to be used to perform the filtering of the at least one pixel of the first area, or determining to not perform the filtering of the at least one pixel of the first area, when the coding information of the second area is to be used to perform the filtering of the at least one pixel of the first area.

Example 31. An apparatus includes means for determining a virtual boundary that separates a picture, or a portion of the picture, into a first area and a second area; and means for, determining to perform filtering of at least one pixel of the first area with coding information of the second area derived from the first area or with the coding information of the second area set to at least one value, when the coding information of the second area is to be used to perform the filtering of the at least one pixel of the first area, or determining to not perform the filtering of the at least one pixel of the first area, when the coding information of the second area is to be used to perform the filtering of the at least one pixel of the first area.

Example 32. A non-transitory program storage device readable by a machine, tangibly embodying a program of instructions executable with the machine for performing operations, the operations including determining a virtual boundary that separates a picture, or a portion of the picture, into a first area and a second area; and determining to perform filtering of at least one pixel of the first area with coding information of the second area derived from the first area or with the coding information of the second area set to at least one value, when the coding information of the second area is to be used to perform the filtering of the at least one pixel of the first area, or determining to not perform the filtering of the at least one pixel of the first area, when the coding information of the second area is to be used to perform the filtering of the at least one pixel of the first area.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows. The acronyms and abbreviations may be appended with each other and/or other characters (e.g. a hyphen (-)).
3GPP 3rd generation partnership project
4G fourth generation of broadband cellular network technology
5G fifth generation cellular network technology
802.x family of IEEE standards dealing with local area networks and metropolitan area networks ABC alternative band classifier
ALF adaptive loop filter
APS adaptation parameter set
ASIC application specific integrated circuit
BD bit depth
BIF bilateral filter
BIF-chroma bilateral filter for chroma
BIF-luma bilateral filter for luma
BO band offset
Cb blue chrominance component
CCALF or CC-ALF cross-component ALF
CCSAO cross-component SAO
CDMA code-division multiple access
CMP cube-map projection
CPE customer premises equipment
Cr red chrominance component
CTB coding tree block
CTU coding tree unit
DBF deblocking filter
DCT discrete cosine transform
DSP digital signal processor
ECM enhanced compression model
EO edge offset
FDMA frequency division multiple access
FPGA field programmable gate array
GDR gradual decoding refresh
GSM global system for mobile communications
H.222.0 MPEG-2 systems, standard for the generic coding of moving pictures and associated audio information
H.26x family of video coding standards in the domain of the ITU-T
HMD head mounted display
IBC intra block copy
id or ID identifier
IEC International Electrotechnical Commission
IEEE Institute of Electrical and Electronics Engineers
I/F interface
IMD integrated messaging device
IMS instant messaging service
I/O input output
IoT internet of things
IP internet protocol
ISO International Organization for Standardization
ISOBMFF ISO base media file format
ITU International Telecommunication Union
ITU-T ITU Telecommunication Standardization Sector
JTC joint technical committee
JVET joint video experts team
LEE laptop embedded equipment
LME laptop-mounted equipment
LTE long-term evolution
ML machine learning
MMS multimedia messaging service
MPEG moving picture experts group
MPEG-2 H.222/H.262 as defined by the ITU
MSE mean squared error
MV multiple views
NAL network abstraction layer
NN neural network
N/W network
PC personal computer
PDA personal digital assistant
PID packet identifier
PLC power line communication
QP quantization parameter or quarter pixel
RAM random access memory
RFID radio frequency identification
RFM reference frame memory
ROM read-only memory
Rx receiver
SAO sample adaptive offset
SMS short messaging service
SPS sequence parameter set
TCP-IP transmission control protocol-internet protocol
TDMA time divisional multiple access
TS transport stream
TV television
Tx transmitter
U blue projection of a chrominance component
UICC universal integrated circuit card
UMTS universal mobile telecommunications system
USB universal serial bus
V red projection of a chrominance component
V2X vehicle-to-everything
VOIP voice over IP
VVC versatile video coding
WLAN wireless local area network
Y luminance component

1-32. (canceled)

33. An apparatus comprising:
at least one processor; and
at least one memory including computer program code;
wherein the at least one memory and the computer program code are configured to, with the at least one processor, cause the apparatus at least to:
determine a virtual boundary that separates a picture, or a portion of the picture, into a first area and a second area; and
determine to perform filtering of at least one pixel of the first area with coding information of the second area derived from the first area or with the coding information of the second area set to at least one value, when the coding information of the second area is to be used to perform the filtering of the at least one pixel of the first area, or not perform the filtering of the at least one pixel of the first area, when the coding information of the second area is to be used to perform the filtering of the at least one pixel of the first area.

34. The apparatus of claim 33, wherein the filtering of the at least one pixel of the first area comprises in-loop filtering.

35. The apparatus of claim 33, wherein the at least one memory and the computer program code are configured to, with the at least one processor, cause the apparatus at least to:
pad pixels in the second area from pixels in the first area, in response to the pixels in the second area being used to perform the filtering of the at least one pixel of the first area.

36. The apparatus of claim 33, wherein the at least one memory and the computer program code are configured to, with the at least one processor, cause the apparatus at least to:
replace pixels in the second area with pixels extrapolated from the first area, in response to pixels in the second area being used to perform the filtering of the at least one pixel in the first area.

37. The apparatus of claim 33, wherein the at least one memory and the computer program code are configured to, with the at least one processor, cause the apparatus at least to:
determine a first output of the filtering of the at least one pixel of the first area, when coding information of the first area and the coding information of the second area are available for the filtering of the at least one pixel of the first area; and
determine a second output of the filtering of the at least one pixel of the first area, when the coding information of the second area is not available for the filtering of the at least one pixel of the first area.

38. The apparatus of claim 37, wherein the at least one memory and the computer program code are configured to, with the at least one processor, cause the apparatus at least to:
determine a difference between the first output and the second output; and
determine an output of filtering at least one pixel of the second area, using at least partially the difference or an approximation of the difference.

39. The apparatus of claim 37, wherein the at least one memory and the computer program code are configured to, with the at least one processor, cause the apparatus at least to:
determine a difference between the first output and the second output;
determine an initial output of filtering at least one pixel of the second area; and
determine a final output of the filtering of the at least one pixel of the second area, with subtracting at least partially the difference from the initial output.

40. The apparatus of claim 39, wherein the weighted contribution comprises 1/2\hat{ }i, wherein i corresponds to an index of a position of the at least one pixel of the first area or the at least one pixel of the second area.

41. The apparatus of claim 33, wherein the at least one memory and the computer program code are configured to, with the at least one processor, cause the apparatus at least to:
determine a target output of a target filtering of the at least one pixel of the first area;
determine an actual output of the filtering of the at least one pixel of the first area, when coding information of the first area or the coding information of the second area is not available to perform the filtering of the at least one pixel of the first area;
determine a difference between the target output and the actual output;
determine an initial output of filtering at least one pixel of the second area; and
determine a final output of the filtering of the at least one pixel of the second area, using the initial output offset at least partially with the difference;
wherein the coding information of the second area comprises the final output of the filtering of the at least one pixel of the second area.

42. The apparatus of claim 33, wherein the at least one memory and the computer program code are configured to, with the at least one processor, cause the apparatus at least to:
determine whether to perform the filtering of the at least one pixel of the first area without using the coding information of the second area, and determine whether to perform filtering of the at least one pixel of the second area without using coding information of the first area, in response to determination of a common option related to the filtering of the at least one pixel of the first area and the filtering of the at least one pixel of the second area, wherein the common option comprises at least one of the following:
determining not to perform filtering of the at least one pixel of the first area, and
determining not to perform filtering of the at least one pixel of the second area;
determining to perform filtering of the at least one pixel of the first area with padding the coding information of the first area; and determining to perform filtering of the at least one pixel of the second area with padding coding information of the second area.

43. The apparatus of claim 33, wherein the at least one memory and the computer program code are configured to, with the at least one processor, cause the apparatus at least to:
perform filtering of at least one pixel of the second area using coding information of the first area and the coding information of the second area.

44. The apparatus of claim 33, wherein the filtering of the at least one pixel of the first area comprises at least one of:
deblocking filtering;
sample adaptive offset edge offset filtering;
bilatering filtering for luma;
bilateral filtering for chroma;
cross-component sample adaptive offset filtering;
adaptive loop filtering; or
cross-component adaptive loop filtering.

45. The apparatus of claim 33, wherein the at least one memory and the computer program code are configured to, with the at least one processor, cause the apparatus at least to one of the following:
disable the filtering of the at least one pixel of the first area up to a number of pixel positions from the virtual boundary; or
perform the filtering of the at least one pixel of the first area up to a number of pixel positions form from the virtual boundary.

46. The apparatus of claim 33, wherein the at least one memory and the computer program code are configured to, with the at least one processor, cause the apparatus at least to perform at least one of:
set pixel values of the second area to be equal to a pixel value of the first area next to the virtual boundary;
set pixel values of the second area to be equal to a mean of pixel values of the first area; or
set pixel values of the second area to be equal to a median of pixel values of the first area;
wherein the coding information of the second area comprises the set pixel values of the second area.

47. The apparatus of claim 33, wherein the at least one memory and the computer program code are configured to, with the at least one processor, cause the apparatus at least to:
determine to perform filtering of at least one pixel of the second area with coding information of the first area derived from the second area or with the coding information of the first area set to at least one value, when the coding information of the first area is to be used to perform the filtering of the at least one pixel of the second area, or determine to not perform the filtering of the at least one pixel of the second area, when the coding information of the first area is to be used to perform the filtering of the at least one pixel of the second area;
disable filtering of at least one pixel of the second area up to a number of pixel positions from the virtual boundary; and
perform the filtering of the at least one pixel of the second area up to a number of pixel positions form from the virtual boundary.

48. The apparatus of claim 47, wherein the at least one memory and the computer program code are configured to, with the at least one processor, cause the apparatus at least to perform at least one of:
set pixel values of the first area to be equal to a pixel value of the second area next to the virtual boundary;
set pixel values of the first area to be equal to a mean of pixel values of the second area; or
set pixel values of the first area to be equal to a median of pixel values of the second area;
wherein the coding information of the first area comprises the set pixel values of the first area.

49. The apparatus of claim 47, wherein the filtering of the at least one pixel of the second area comprises at least one of:
in-loop filtering;
deblocking filtering;
sample adaptive offset edge offset filtering;
bilatering filtering for luma;
bilateral filtering for chroma;
cross-component sample adaptive offset filtering;
adaptive loop filtering; or
cross-component adaptive loop filtering.

50. The apparatus of claim 33, wherein the at least one memory and the computer program code are configured to, with the at least one processor, cause the apparatus at least to:
determine the at least one value with a bit depth BD.
determine the at least one value as 2\hat{ }(BD−1).

51. A method comprising:
determining a virtual boundary that separates a picture, or a portion of the picture, into a first area and a second area; and
determining to perform filtering of at least one pixel of the first area with coding information of the second area derived from the first area or with the coding information of the second area set to at least one value, when the coding information of the second area is to be used to perform the filtering of the at least one pixel of the first area, or determining to not perform the filtering of the at least one pixel of the first area, when the coding information of the second area is to be used to perform the filtering of the at least one pixel of the first area.
